(19) United States
(12) Patent Application Publication
(10) Pub. No.: US 2007/0097326 A1
(43) Pub. Date: May 3, 2007

(54) Digital rear-projection display apapratus and method for adjusting a displayed image thereof

(76) Inventor: Jung-Yi Yang, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/261,165

(22) Filed: Oct. 28, 2005

(51) Int. Cl. G03B 21/14; G03B 21/00

(52) U.S. Cl. 353/69

(57) ABSTRACT

A method for adjusting a displayed image of a digital rear-projection display apparatus and a digital rear-projection display apparatus are disclosed. The method for adjusting the displayed image comprises adjusting the size of the image displayed on the digital display panel for a desired display area on the digital display panel, which is smaller than the original display area on the digital display panel, wherein the image is entirely displayed on a fixed screen after projection. The digital rear-projection display apparatus comprises a fixed screen and an image projection display module. The image projection display module including a digital display panel scales and projects the image displayed on the digital display panel to the fixed screen, wherein the digital rear-projection display apparatus further comprises an input interface for adjusting the image displayed on the digital display panel.

### BACKGROUND OF THE INVENTION

1. Field of the Invention

The present invention relates to a method for adjusting a displayed image of a display apparatus, specifically to a method for adjusting a displayed image of a digital rear-projection display apparatus. The present invention also relates to a digital rear-projection display apparatus.

2. Description of the Related Art

In recent years, digital display devices (e.g., as liquid crystal displays LCDs, digital micromirror devices DMDs and plasma displays panels PDPs) have replaced traditional analog display devices (e.g., CRTs) for widely used in new generation of display apparatuses. Since digital image signals have features of lossless and clear in transmission and processing, it is a new trend to use the digital display devices in projection display apparatus (e.g., digital rear-projection display apparatus). However, it is difficult for the digital projection display apparatus to adjust the size and position of a displayed image. linearly like the analog display devices because the resolution, i.e., number of display pixels, of the digital display device is fixed (e.g., 1024×768 or 800×600).

A mechanical design for the digital rear-projection display apparatus should consider both precision in manufacturing and assembly as well as fine adjustment capability so that the display devices can be fixed in a best position to project all display pixels on a display screen through an optical system. FIG. 1 is a schematic view showing the optical path of a simplified rear-projection display apparatus, in which a mechanical adjusting device 110 provides a fine adjustment capability for holding an optical engine 120 thereon to the best position. The image projection display module (not shown) disposed inside the optical engine 120 projects an image through a projection lens 121 and a reflective mirror 130 and finally reflects the displayed image on a screen 140.

Since the number of display pixels for the digital display device employed in the digital rear-projection display apparatus is fixed, it is usually a problem to adjust the mechanical assembly. That is, the relative positions of the screen 140, the reflective mirror 130 and the optical engine 120 should be adjusted adequately during assembly so as to display the image completely and correctly on the screen 140. Those manufacturing and assembly satisfying the above requirements would be too complicated to keep a high production and operation efficiency due to time-consuming adjusting processes. Furthermore, the entire tolerance requirement in mechanical assembly should be stricter and thus results in difficulty in production and higher cost for manufacture.

In order to solve these problems, a prior-art solution adds redundant pixels (e.g., SONY LCD) around an original active display area of a digital display panel. FIG. 2 illustrates an existing art which adds an additional redundant area around an active display area. As shown in FIG. 2, an active display area 210 is an image display area according to standard resolutions (e.g., 1024×768 or 800×600). In response to the requirements of the mechanical positioning and the purpose of adjustment by electrical signals, a redundant area (pixels) 220 is added to the original active display pixels for adjusting the assembly. In other words, the manufacturer can use these redundant pixels (220) to satisfy the positioning requirements and adjust the display position of the active display area 210 on the digital rear-projection display apparatus by electrical signals to achieve the purposes of assembly and adjustment.

However, the prior art technology heavily relies on the extra redundant pixels provided by the digital display panel. That is, the whole display area of the display panel should be enlarged. In practice, to enlarge the display area of the display panel will certainly reduce the production yield rate and increase the production cost.

Another image size adjusting solution has been disclosed in U.S. Pat. No. 6,499,849 which utilizes a set of zoom lens to adjust the size of projection images. One drawback of this art is that the zoom lens is too expensive to be used in the rear-projection apparatus.

Yet another prior art solution is to design the optical path for projection image larger than the screen (i.e., overscan) so that the screen may fill with only a portion of the entire image but the surrounding portion of the image is out of the screen. One drawback of this art, however, is that partial content of the image (i.e., the surrounding of images) cannot be displayed on the screen. If the displayed image is from a computer video signal, the low reproduction rate would be a problem in applications because the surrounding of computer video screen always contains some important information, such as status bar, shortcut bar and scroll bar. Consequently, this prior art solution is inconvenient in use.

### SUMMARY OF THE INVENTION

An object of this invention is to provide a method for adjusting a displayed image of a digital rear-projection display apparatus. By reducing a displayed image, the surrounding area of the display panel can be used to adjust the display position to result in flexibility of the assembly precision and improve operability of assembly. Hence, the production efficiency is enhanced and the cost is reduced.

Another object of this invention is to provide a digital rear-projection display apparatus which uses a method for adjusting a displayed image of a digital rear-projection display apparatus by reducing the display area of the digital display panel required for the original image. The surrounding area of the display panel can therefore be used to adjust the display position. The present invention can result in flexibility of the assembly precision and improve operability of assembly. Hence, the production efficiency is enhanced and the cost is reduced.

The present invention discloses a method for adjusting a displayed image of a digital rear-projection display apparatus. The digital rear-projection display apparatus comprises a fixed screen and an image projection display module for receiving an input image and projecting an image. The image projection display module includes a digital display panel which displays the image with a standard (native) resolution. The image projection display module receives an input image, scales the input image, outputs a display signal for displaying the image on the digital display panel and projects the image displayed by the digital display panel to the fixed screen. The digital rear-projection display apparatus further comprises an input interface for adjusting the displayed image displayed on the digital display panel. The method for adjusting a displayed image comprises adjusting the image size of the digital display panel to a desired display area so that the desired display area on the digital display panel is smaller than the original display area of the digital image panel under the standard resolution. The image after projection is entirely displayed on the fixed screen.

According to one embodiment of this invention, the method for adjusting a displayed image of a digital rear-projection display apparatus further comprises the step of setting a capture area for capturing the input image without clipping the image content and scaling the captured image to display on the desired area of the digital image panel such that the input image is entirely displayed on the fixed screen after projection.

According to a preferred embodiment of this invention, the method for adjusting a displayed image of a digital rear-projection display apparatus further comprises a step for determining a relative position of the desired display area on the digital display panel. In other words, this step comprises adjusting a horizontal displacement which is a distance between one of the vertical sides of the desired display area and a corresponding vertical side of the original display area and adjusting a vertical displacement which is a distance between one of the horizontal sides of the desired display area and a corresponding horizontal side of the original display area.

According to the preferred embodiment of this invention, the method for adjusting a displayed image of a digital rear-projection display apparatus further comprises a step for setting default values for sizes of the image, the horizontal displacement, and the vertical displacement.

According to the preferred embodiment of this invention, the method for adjusting a displayed image of a digital rear-projection display apparatus further comprises a step for outputting a display timing according to an adjusted size of the image, an adjusted value of the horizontal displacement and an adjusted value of the vertical displacement for displaying the entire input image on the desired display area.

According to the preferred embodiment of this invention, the method for adjusting a displayed image of a digital rear-projection display apparatus further comprises a step for generating a horizontal data enable signal and a vertical data enable signal respectively according to a width and a height of the origin display area, wherein the above step for adjusting the image size for the digital display panel is to adjust the size of the image by determining a desired display width signal and a desired display height signal.

According to the method for adjusting a displayed image of a digital rear-projection display apparatus, the step for adjusting a horizontal displacement is implemented by adjusting a timing distance between a leading edge of the horizontal data enable signal and a leading edge of the desired display width signal so as to determine the horizontal displacement. Similarly, the step for adjusting a vertical displacement is implemented by adjusting a timing distance between a leading edge of the vertical data enable signal and a leading edge of the desired display height signal so as to determine the vertical displacement.

According to the method for adjusting a displayed image of a digital rear-projection display apparatus, the step for adjusting the displayed image size for the digital display panel comprises selecting whether to adjust a width of the desired display area. If positive, the width is adjusted. The step further comprises selecting whether to adjust a height of the desire display area.

If positive, the height is adjusted. The present invention also discloses a digital rear-projection display apparatus, which comprises a fixed screen, an image projection display module and an input interface. The image projection display module comprises a scaler and a digital display panel. The image projection display module projects an image displayed by the digital display panel to the fixed screen. The scaler is used to receive an input image, to adjust the image and to display the image at a desired display area on the digital display panel, wherein the desired display area is smaller than the original display area of the digital image panel with a standard resolution. The input interface, coupled to the image projection display module, is used for inputting a command to adjust the image to be projected by the image projection display module, wherein the image after adjusted is entirely projected and displayed on the fixed screen.

According to the digital rear-projection display apparatus described in one embodiment of this invention, the scaler sets a capture area for capturing the input image without clipping the image content and scales the captured image to display on the desired area of the digital image panel such that the input image is entirely displayed on the fixed screen after projection.

According to the digital rear-projection display apparatus described in one embodiment of this invention, the scaler generates a data enable signal which comprises a horizontal data enable signal and a vertical data enable signal relative to a data width and a data height respectively according to a width and a height of the original display area. The scaler further sets the size of the displayed image with a desired display width signal and a desired display height signal respectively according to a width and a height of the desired display area.

According to the digital rear-projection display apparatus described in the preferred embodiment of this invention, the scaler further decides a horizontal relative position of the desired display area in the original display area by adjusting a timing distance between a leading edge of the horizontal data enable signal and a leading edge of the desired display width signal. Similarly, the scaler further decides a vertical relative position of the desired display area in the original display area by adjusting a timing distance between a leading edge of the vertical data enable signal and a leading edge of the desired display height signal.

Since the present invention releases the surrounding area for adjusting the display position by reducing the displayed image, the extra redundant area provided by the digital display panel is unnecessary. Consequently, the present invention may result in flexibility of the assembly precision and improve operability of assembly. Hence, the production efficiency is enhanced and the cost is reduced. Another advantage of the present invention is that the whole image received from computer video signals can be totally reproduced in the display, i.e., the reproduction rate of the input image is 100%. In other words, all the contents of the computer video signals can be displayed on the projection screen without clipping any part of the surrounding area of the display.

Further objects and advantages for the present invention will become apparent from a consideration of the following description and drawings. The detailed technology and preferred embodiments implemented for the subject invention are described in the following paragraphs accompanying the appended drawings.

### BRIEF DESCRIPTION OF THE DRAWINGS

FIG. 1 is a schematic view showing the optical path of a simplified rear-projection display apparatus;

FIG. 2 is a schematic view showing an active display area of the prior art with an additional redundant area;

FIG. 3 is a schematic view showing a display panel according to one embodiment of the present invention, in which the display panel has a reserved area by reducing the original display area;

FIG. 4 is a flow chart for adjusting a displayed image of a digital rear-projection display apparatus according to one embodiment of the present invention;

FIG. 5 is a block diagram of a digital rear-projection display apparatus according to one embodiment of the present invention;

FIG. 6 is a block diagram of a scaler according to one embodiment of the present invention; and

FIG. 7 is a display timing diagram of a digital rear-projection display apparatus according to one embodiment of the present invention;

FIG. 8 is an input timing diagram for capturing an input image of a scaler according to one embodiment of the present invention;

FIG. 9 is a schematic view showing the relation of a screen, a keystone projection image, and a projection image after keystone correction.

### DESCRIPTION OF THE PREFERRED EMBODIMENT

In consideration of the drawbacks of prior art technologies, the subject invention discloses a method by reducing a displayed image to release a surrounding area of a display panel for adjusting a display position. FIG. 3 illustrates a desired display area with a reserved area of the display panel according to one embodiment of the present invention. A digital display panel in this embodiment is a display panel (such as a DMD) without a redundant area. Consequently, such digital display panel is not suitable for the prior art technologies. In general applications, the digital display panel displays an image on an active display area 310 with a standard resolution. According to the above embodiment, the displayed image can be scaled down to a desired display area 330. A surrounding reserved area 320 released from the active display area 310 of the digital display panel after the image being scaled down can be used for adjusting the display position. With this approach, the difficulty in choosing the display panels in prior art technologies can be overcome. The present invention can result in flexibility of the assembly precision, improve the operability of assembly, enhance the production efficiency and reduce the cost for manufacture.

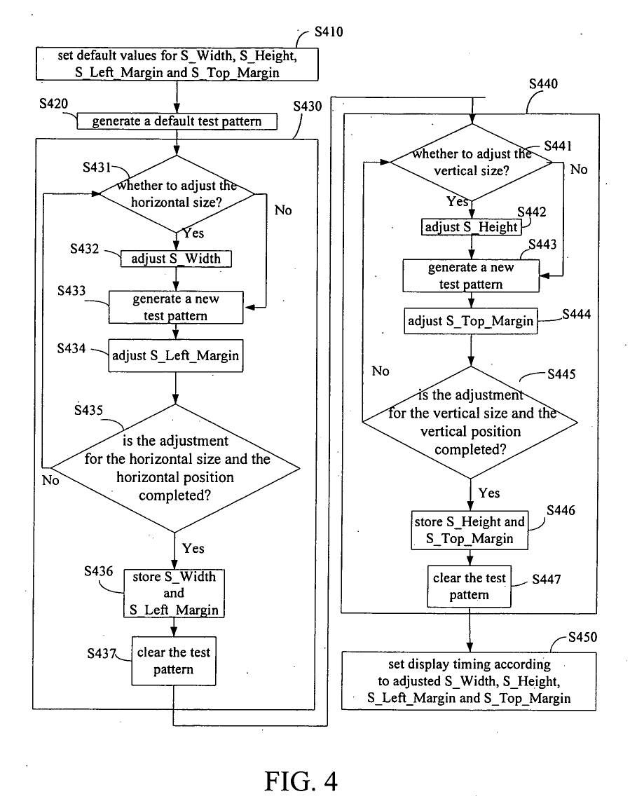

FIG. 4 shows a flow chart of a method for adjusting a displayed image of a digital rear-projection display apparatus according to one embodiment of the present invention. As shown in FIG. 3 and FIG. 4, an A_Width and an A_Height represent a width and a height for the active display area of the digital display panel, respectively. An S_Width and an S_Height represent a width and a height after the active display area is properly shrunk (i.e., desired display area), respectively. An S_Left_Margin, an S_Right_Margin, an S_Top_Margin and an S_Bottom_Margin represent a left margin distance, a right margin distance, a top margin distance and a bottom margin distance between the desired display area 330 and the active display area 310, respectively.

The first step S410 will set default values for the width S_Width of the desired display area, the height S_Height of the desired display area, the left margin distance S_Left_Margin and the top margin distance S_Top_Margin between the desired display area 330 and the active display area 310 (for the sake of simplicity, abbreviated as a horizontal displacement and a vertical displacement, respectively). Although in this embodiment the relative position between the desired display area 330 and the active display area 310 is defined by the S_Left_Margin and the S_Top_Margine, persons skilled in this field know that there are other ways to define them and get the same result as the subject invention does (e.g., using the right margin distance S_Right_Margin and the bottom margin distance S_Bottom_Margin to define the relative position).

In step S420, a default test pattern is generated for further reference of adjusting. Said default test pattern disclosed herein is a rectangular frame pattern, preferably with one-pixel line width, with the width set by the S_Width and the height set by the S_Height. The relative position of the rectangular frame pattern on the active display area 310 is set according to the horizontal displacement S_Left_Margin and the vertical displacement S_Top_Margin. The rectangular frame pattern equivalently marks the size and the position of the desired display area 330 in the following adjustment. According to the default test pattern, a horizontal width (the width S_Width of the desired display area), the horizontal displacement S_Left_Margin (step S430), a vertical height (the height S Height of the desired display area) and the vertical displacement S_Top_Margin (step S440) are adjusted. After completing the adjustments for the size of the desired display area 330 and the relative position of the desired display area 330 in the active display area 310, the adjusted and decided parameters including the width S_Width of the desired display area, the height S Height of the desired display area, the horizontal displacement S_Left_Margin and the vertical displacement S_Top_Margin are stored. Accordingly, the digital rear-projection display apparatus outputs a display timing to display the image on the desired display area 330 according to the stored parameters.

For the sake of convenience, parameters including the width S_Width of the desired display area, the height S_Height of the desired display area, the horizontal displacement S_Left_Margin and the vertical displacement S_Top_Margin are abbreviated as “display parameters.”

According to the embodiment, step S430 can be implemented as follows: in step S431, selecting whether to adjust the horizontal size is executed. If positive, step S432 is executed to adjust the width S_Width of the desired display area and step S433 is then executed. If negative, step S433 is executed directly.

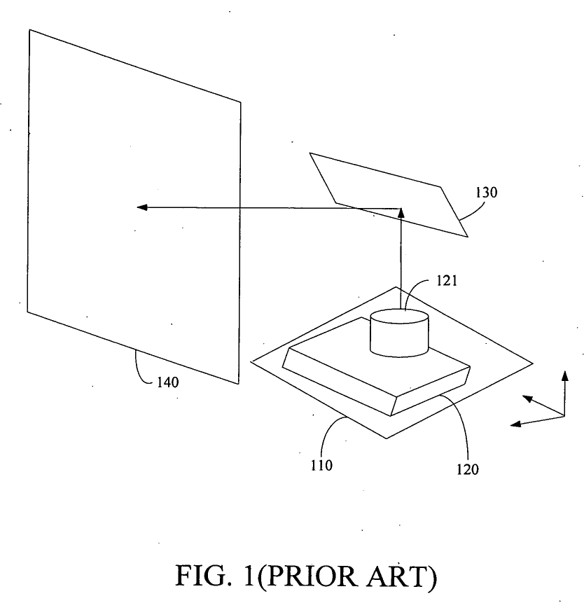

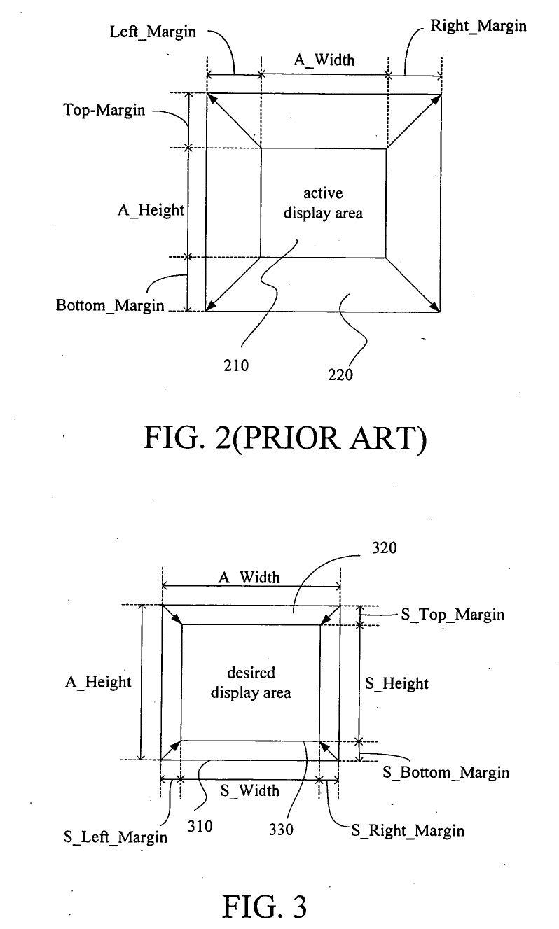

In step S433, a new test pattern is generated according to the adjusted display parameters which are prepared for further reference of adjusting. In step S434, the horizontal position is adjusted according to the horizontal displacement S_Left_Margin as an example. The adjustment can be performed as an example as follows: watching the position of the test pattern (i.e., the desired display area 330) projected on the fixed screen (as shown in screen 140 of FIG. 1) by eyes, and adjusting the test pattern (i.e., the desired display area 330) to a best position.

In step S435, people responsible for adjusting must decide whether the adjustment for said horizontal size and said horizontal position is completed. If negative, the method returns to step S431 to repeat steps S431 to S434. If positive, the adjusted width S_Width of the desired display area and the adjusted horizontal displacement S_Left_Margin are stored (step S436) and the test pattern is cleared (step S437).

According to the embodiment, step S440 can be implemented as follows: in step S441, selecting whether to adjust the vertical size is executed. If positive, step S442 is executed to adjust the height S Height of the desired display area and step S443 is then executed. If the result of step S441 is negative, step S443 is executed directly.

In step S443, a new test pattern is generated according to the adjusted display parameters which are prepared for further reference of adjusting. In step S444, the vertical position is adjusted according to the vertical displacement S Top_Margin as an example. The adjustment can be performed as an example as follows: watching the position of the test pattern (i.e., the desired display area 330) projected on the fixed screen (as shown in screen 140 of FIG. 1) by eyes, and adjusting the test pattern (i.e., the desired display area 330) to a best position.

In step S445, people responsible for adjusting must decide whether the adjustment for said vertical size and said vertical position is completed. If negative, the method returns to step S441 to repeat steps S441 to S444. If positive, the adjusted height S_Height of the desired display area and the adjusted vertical displacement S_Top_Margin are stored (step S446) and the test pattern is cleared (step S447).

Finally, in step S450, the adjusted parameters including the width S_Width of the desired display area, the height S_Height of the desired display area, the horizontal displacement S_Left_Margin and the vertical displacement S_Top Margin are used for setting a display timing signal and a horizontal/vertical scaling factor to display the image on the desired display area 330, wherein the horizontal/vertical scaling factor is calculated from the S_Width/S_Height and a capture width / a capture height of an input image. The details will be discussed in the following sections.

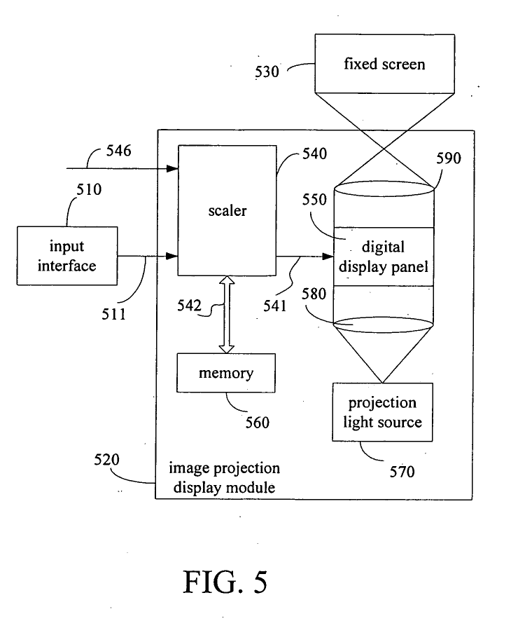

Another embodiment is described as follows to introduce another implementation of the subject invention. FIG. 5 is a block diagram of a digital rear-projection display apparatus according to one embodiment of the present invention. Users can operate, for example, an input interface 510 to generate a selection/setting signal 511 which is transmitted to an image projection display module 520. The image projection display module 520 adjusts the image, for example, according to the selection/setting signal 511 and the method for adjusting a displayed image, and projects the image on a fixed screen 530, wherein the method for adjusting a displayed image is described in previous embodiments so verbosity is not given here.

The image projection display module 520 comprises a scaler 540 to receive an image signal 546 and the selection/setting signal 511 and to generate a required display signal 541, including a display timing signal and an image signal, for a digital display panel 550. The image signal 546 may come from a video signal source, e.g., a DVD player, or a computer video graphics adapter (VGA) card. In addition, the scaler 540 stores adjusted parameters into a memory 560 after adjusting the image according to the method for adjusting a displayed image.

A projection light source 570 provides a projection light to transmit from a first set of lens 580 to the digital display panel 550 to illuminate the digital display panel 550 such that the image can be projected and focused through a second set of lens 590 on the fixed screen 530 to form a projection image.

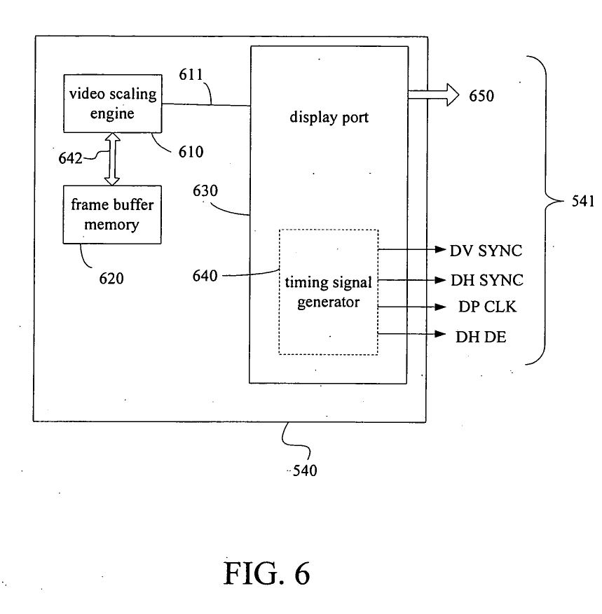

The scaler 540 according to the embodiment is shown in FIG. 6. FIG. 6 is a block diagram of a scaler according to one embodiment of the present invention. The scaler 540 comprises a video scaling engine 610 for scaling and frame-rate converting the input image signal. A frame buffer memory 620 is used for storing required frame data for the video scaling engine 610. A display port 630 receives the image signal and a control signal 611 from the video scaling engine 610 and outputs a display signal 541 which comprises a display timing signal and an image signal 650. The display timing signal comprises a vertical synchronous signal DV_SYNC, a horizontal synchronous signal DH_SYNC, a clock signal DP_CLK and a horizontal data enable signal DH_DE, wherein signals DV_SYNC, DH_SYNC, DP_CLK and DH_DE are provided by a timing signal generator 640.

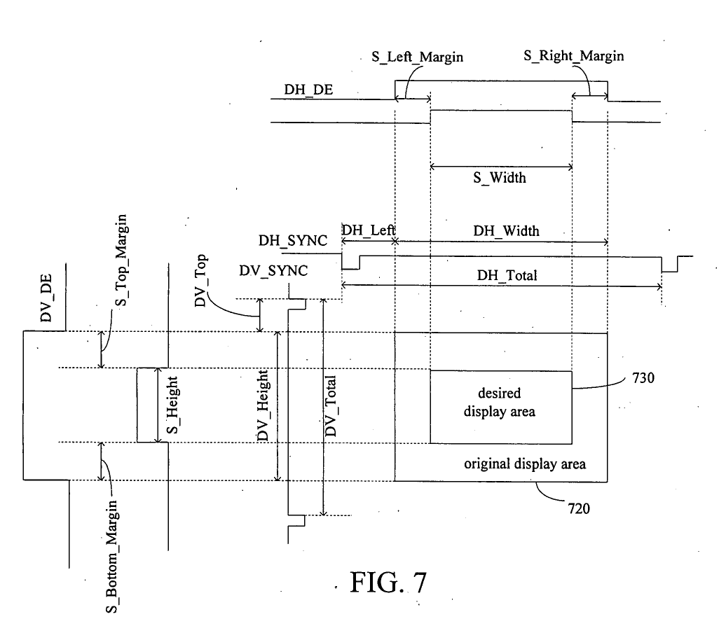

FIG. 7 is a display timing diagram for a digital rear-projection display apparatus according to one embodiment of the present invention. In FIG. 7, the relationship among these synchronous signals, i.e., DH_SYNC, DV_SYNC, DH_DE, DV_DE, can be clearly observed. The period of DH_SYNC, DV_SYNC, DH_DE and DV_DE and the relationship among these signals are set and characterized by a set of display port registers in a typical scaler. All symbols for characterizing these synchronous signals in the display timing diagram of FIG. 7 may represent their corresponding registers in a scaler. For example, the period of the horizontal synchronous signal DH_SYNC and the period of the vertical synchronous signal DV_SYNC are determined by contents of registers, DH_Total and DV_Total respectively. The horizontal data enable signal DH_DE lags behind the horizontal synchronous signal DH_SYNC by DH_Left and is active for the period of DH_Width, wherein the unit of both DH_Left and DH_Width is clock (DP_CLK). Therefore, the horizontal data enable signal DH_DE is characterized and set by the registers, DH_Left and DH_Width. Furthermore, the desired output display pixels may be set to lag behind DH_DE by S_Left Margin and are active for a period S_Width. Similarly, the vertical data enable signal DV_DE lags behind the vertical synchronous signal DV_SYNC by DV_Top and is active for the period of DV_Height, wherein the unit of both DV_Top and DV_Height is line. Therefore, the vertical data enable signal DV_DE is characterized and set by the registers, DV_Top and DV_Height. Furthermore, the desired output display lines may be set to lag behind DV_DE by S_Top Margin and are active for a period S_Height.

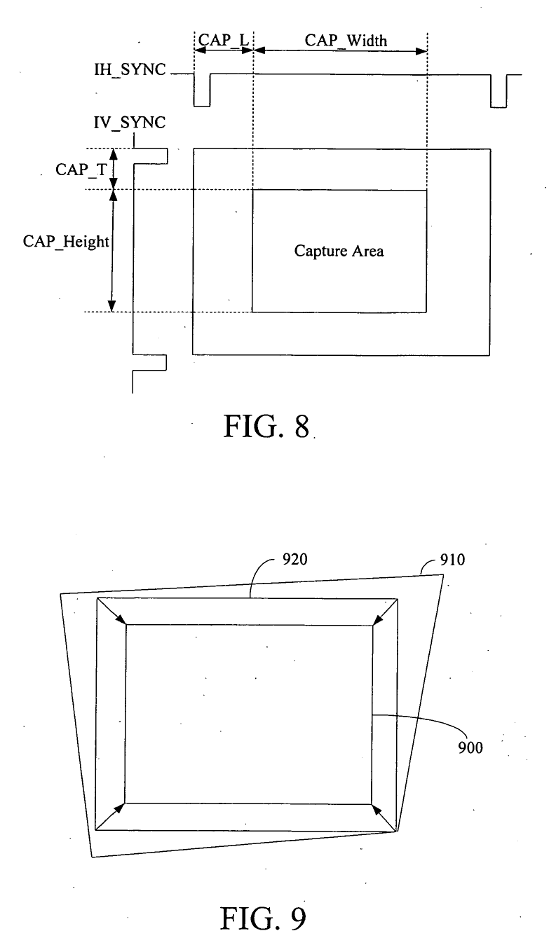

A scaler according to a preferred embodiment of the present invention further comprises a set of registers for setting an image capture area of an input image. An input horizontal synchronous signal IH_SYNC, an input vertical synchronous signal IV_SYNC, the capture area and related registers for setting the capture area are shown as FIG. 8. The capture area of the input image is set by registers, horizontal capture start CAP_L, capture width CAP_Width, vertical capture start CAP_T and capture height CAP_Height. Only the image content within the capture area will be processing and scaling by the scaler and finally be converting to a displayed image on a digital display panel. In the preferred embodiment of the present invention, the capture area is configured to capture the entire image content of the input.

As described in previous embodiment, the subject invention can also be applied in general display panels (i.e., panels without the redundant area). The effective display pixels of the standard resolution of the display panel are mapped to the original display area 720 in FIG. 7. The width and height of the original display area 720 are determined respectively by the horizontal data enable signal DH_DE and the vertical data enable signal DV_DE, wherein the vertical data enable signal DV_DE is an internal reference signal of the scaler 540. A general scaler does not output such a signal. Instead, this signal is embedded in the horizontal data enable signal DH_DE. The position of the original display area 720 on the display panel can be determined by adjusting both the timing distance DH_Left between the leading edge of the horizontal synchronous signal DH_SYNC and the leading edge of the horizontal data enable signal DH_DE, and the timing distance DV_Top between the leading edge of the vertical synchronous signal DV_SYNC and the leading edge of the vertical data enable signal DV_DE. In general applications, the digital rear-projection display apparatus outputs the timing signal of the effective display pixels corresponding to a standard resolution according to the timing specification of the employed display panel, wherein the display area is shown as the original display area 720 in FIG. 7.

As described above, the required synchronous signals for the digital display panel can be set by the stored parameters in related registers of the timing signal generator 640 in the scaler 540, wherein the S_Width and the S_Left_Margin are used respectively to set a horizontal pixel number and a horizontal start position (relative to the horizontal data enable signal DH_DE) of the physical output display (desired display area 730) for the scaler, and the S_Height and the S Top Margin are used respectively to set a line number and a vertical start position (relative to the vertical data enable signal DV_DE) of the physical output display for the scaler. The scaler can calculate the physical horizontal/vertical scaling factors according to the S_Width/S_Height and the capture width (CAP_Width)/capture height (CAP_Height) of the input image. Depending on the design of the scaler, the scaler can precisely set the output display with different resolutions and with the size defined by the S_Width and S_Height according to the setting of either the S_Width/S_Height registers or the registers relative to the horizontal/vertical scaling factors. After properly setting of the registers of the scaler, the scaler scales the input image and outputs an image with the exact size as defined by S_Width/S_Height at the location defined by S_Left_Margin/S_Top_Margin on the employed display panel. The image on the digital display panel is entirely displayed without clipping on a fixed screen after projection.

In the application of the present invention, the optical path of the digital rear-projection display apparatus should be designed to project an image a little bit larger than the screen (i.e., overscan) and adjusts the electronics signals as disclosed in the present invention to shrink the displayed image and to position the displayed image to fit on the fixed screen accurately.

Although the keystone distortion problem, which can often be found in a typical projection display, is beyond of the scope of the present invention, persons skilled in this field may know that a keystone correction can be executed prior to the execution of the disclosed method of the present invention and benefits from the method disclosed in the present invention thereafter. FIG. 9 shows the relation of a screen 900, a keystone projection image 910 and a corrected image 920 after keystone correction. Since the corrected image 920 after keystone stone correction is a rectangular image which is a little bit larger than the screen. Therefore, the method for adjusting a displayed image of a digital rear-projection display apparatus as disclosed in the present invention will be appreciated and applicable after the keystone correction to achieve the same objects and advantages of the present invention. A scaler suitable for such an application should be a scaler with the keystone correction function as well as the aforementioned scaling functions and features.

The above disclosures are related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for adjusting a displayed image of a digital rear-projection display apparatus, the digital rear-projection apparatus comprising a fixed screen and an image projection display module for receiving an input image and projecting an image, the image projection display module including a digital display panel which displays the image at an original display area on the digital display panel with a standard resolution, and the image projection display module scaling the input image and projecting the image displayed on the digital display panel to the fixed screen, wherein the digital rear-projection display apparatus further comprises an input interface for adjusting the image displayed on the digital display panel, the method comprising:
adjusting the size of the image displayed on the digital display panel to a desired display area on the digital display panel, the desired display area being smaller than the origin display area on the digital display panel, wherein the image is entirely displayed on the fixed screen after projection.

2. The method according to claim 1, further comprising:
adjusting a horizontal displacement, the horizontal displacement being a distance between one of vertical sides of the desired display area and a corresponding vertical side of the original display area; and
adjusting a vertical displacement, the vertical displacement being a distance between one of horizontal sides of the desired display area and a corresponding horizontal side of the original display area.

3. The method according to claim 2, further comprising setting default values for sizes of the image, the horizontal displacement, and the vertical displacement.

4. The method according to claim 2, further comprising outputting a display timing according to an adjusted size of the image, an adjusted value of the horizontal displacement and an adjusted value of the vertical displacement for displaying the entire input image on the desired display area.

5. The method according to claim 2, further comprising:
generating a horizontal data enable signal and -a vertical data enable signal respectively according to a width and a height of the origin display area, and adjusting the size of the image by determining a desired display width signal and a desired display height signal.

6. The method according to claim 5, further comprising determining the horizontal displacement by adjusting a timing distance of a leading edge of the horizontal data enable signal and a leading edge of the desired display width signal.

7. The method according to claim 5, further comprising determining the vertical displacement by adjusting a timing distance of a leading edge of the vertical data enable signal and a leading edge of the desired display height signal.

8. The method according to claim 1, further comprising:
adjusting a relative position of the desired display area in the digital display panel.

9. The method according to claim 1, further comprising:
selecting whether to adjust a width of the desired display area, if yes, then adjusting the width, if negative, unchanging the width; and
selecting whether to adjust a height of the desire display area, if yes, then adjusting the height, if negative, unchanging the height.

10. A digital rear-projection display apparatus comprising:
a fixed screen;
an image projection display module, comprising a scaler for receiving and scaling an input image and a digital display panel for displaying an image at an original display area on the digital display panel with a standard resolution, the image projection display module projecting the image displayed on the digital display panel to the fixed screen, the scaler adjusting the image to display the image at a desired display area of the digital display panel, wherein the desired display area is smaller than the origin display area; and
an input interface, coupled to the image projection display module, for inputting a command to adjust the image to be projected by the image projection display module,
wherein the image after adjusting is entirely displayed on the fixed screen after projection.

11. The digital rear-projection display apparatus of claim 10, wherein the scaler generates a data enable signal which comprises a horizontal data enable signal and a vertical data enable signal relative to a data width and a data height according to a width and a height of the original display area, and the scaler further sets the size of the displayed image with a desired display width signal and a desired display height signal respectively according to a width and a height of the desired display area.

12. The digital rear-projection display apparatus of claim 11, wherein the scaler further decides a horizontal relative position of the desired display area in the original display area by adjusting a timing distance between a leading edge of the horizontal data enable signal and a leading edge of the desired display width signal.

13. The digital rear-projection display apparatus of claim 11, wherein the scaler further decides a vertical relative position of the desired display area in the origin display area by adjusting a timing distance between a leading edge of the vertical data enable signal and a leading edge of the desired display height signal.
